(19) United States
(12) Patent Application Publication
(10) Pub. No.: US 2020/0031319 A1
(43) Pub. Date: Jan. 30, 2020

(54) SYSTEMS, METHODS, AND DEVICES FOR EXAHUST RECIRCULATION OF VEHICLE WASH VACUUMS

(71) Applicant: Motor City Wash Works, Inc., Wixom, MI (US)

(72) Inventors: Lionel Belanger, Northville, MI (US); Robert J. Wentworth, Farmington Hills, MI (US)

(73) Assignee: Motor City Wash Works, Inc., Wixom, MI (US)

(21) Appl. No.: 16/352,448

(22) Filed: Mar. 13, 2019

Related U.S. Application Data
(60) Provisional application No. 62/703,131, filed on Jul. 25, 2018.

(51) Int. Cl. B60S 3/00; A47L 7/00

(52) U.S. Cl. CPC B60S 3/008; A47L 7/0076

(57) ABSTRACT

Disclosed are exhaust heat recirculation systems for vehicle wash vacuums, methods for making/using such vacuum exhaust heat recirculation systems, and vehicle wash facilities with a central vacuum system having exhaust recirculation capabilities. A vehicle wash facility includes multiple vehicle stalls, and a vacuum system for removing debris from vehicles at the vehicle stalls. The vacuum system includes vacuum hoses mounted at the vehicle stalls, a central power unit that generates vacuum pressure for operating the hoses, and feeders for connecting the hoses to an inlet manifold of the central power unit. An exhaust heat recirculation system is operatively connected to and evacuates exhaust gases from the central power unit. The vacuum system may include a continuous-belt heater unit that receives the evacuated exhaust gases and repurposes the gas for drying towels, mitter cloth strips, brushes, etc.

### CROSS-REFERENCE AND CLAIM OF PRIORITY TO RELATED APPLICATION

This application claims the benefit of, and priority to, U.S. Provisional Patent Application No. 62/703,131, which was filed on Jul. 25, 2018, and is incorporated herein by reference in its entirety and for all purposes.

### TECHNICAL FIELD

The present disclosure relates generally to vehicle wash systems. More specifically, aspects of this disclosure relate to car wash vacuums for removing debris from automobiles.

### INTRODUCTION

Vehicle washing systems are available in both the public and private sectors for cleaning and drying vehicles of various types, including passenger cars, busses, trucks, train cars, boats, and even airplanes. Large-volume automated washing systems, or “car washes” for example, typically utilize a conveyer arrangement for successively moving vehicles through a series of electronically controlled washing and rinsing stations. When the washing and rinsing operations are complete, the vehicle is then moved through a drying station, which serves to remove remnants of soap, water and debris from exterior surfaces of the vehicle. Another category of automated systems for washing and drying vehicles—known colloquially as “rollover car washes”—retain the vehicle in a fixed position and sequentially move various cleaning, rinsing, and drying machines over the vehicle to complete a wash operation. Also available are different types of manual washes, including “self-service” commercial washes and “hand-wash” establishments where either the vehicle owner or paid service personnel performs the washing tasks using hoses, sponges and towels to wash then dry the vehicle.

### SUMMARY

Disclosed herein are automated canopy systems for selectively covering and uncovering a vehicle, exhaust heat recirculation systems for repurposing gases vented from a vacuum power unit, methods for making and methods for using any such canopy systems and/or exhaust heat recirculation systems, and vehicle wash systems equipped with automated canopies and/or vacuum exhaust recirculation capabilities. By way of example, there is presented a vehicle wash facility with a centralized vacuum system that utilizes a central power unit (e.g., a 25 to 150 horsepower (hp) motor) to create vacuum pressure for generating suction to provide airflow through vacuum hoses that are provided at individual vehicle drying stations. Operation of the motor causes the motor to become hot, and the airflow (i.e., gas) through the motor serves to cool the motor, while causing the air to become heated when it is exhausted from the motor (i.e., central power unit). It is known that the exhaust temperature of the exhausted air is great enough that, in many instances, the exhausted air is exhausted through a duct, directly to the atmosphere, to prevent the location where the motor is operating from becoming overheated, while wasting the heated air.

A vacuum exhaust heat recirculation device is provided to capture heat from the heated air, generated as a byproduct of operation of the central power unit. This heated air may be captured and repurposed to dry towels, sponges, employee uniforms, mitter cloth strips, drying material, vehicles, etc.

For at least some applications, the exhaust heat recirculation system may include a manifold assembly for collecting and distributing waste gases generated during operation of the power unit, and a filter for removing errant debris and/or noxious chemicals entrained in the gaseous flow. Once filtered, the exhaust gases may be evacuated to a dryer unit through an exhaust pipe, hose, or channel (referred to collectively as “conduit”). One or more fluid control valves may be governed by an electronic controller to selectively feed, meter, suspend, or otherwise govern fluid flow through the exhaust heat recirculation system. For at least some applications, an exhaust heat recirculation system may include a heat exchanger to recover the waste heat energy. The recovered waste heat energy may be used to heat air for a dryer unit, a water heater, a heating, ventilation and air conditioning (HVAC) system, etc. In at least some applications, dryer unit may be disposed in a location of the vehicle wash facility that is spaced from the location of the central power unit, where the exhausted heated air flows to an exhaust vent, via a duct, where the heated air is directed to dry towels, sponges, employee uniforms, mitter cloth strips, drying material, vehicles, etc. In some instances, utilizing the heated air that is exhausted through the vent may provide the benefits and functionality provided by motor operated blowers that typically operated in-line in a vehicle wash facility, without the noise of blower, since the heated air is provided by the motor of the central power unit that is located remote to the in-line operation. Further, utilizing the exhausted heated air saves energy by replacing or otherwise supplementing energy intensive drying operations, since this air would have been otherwise vented directly to atmosphere and not repurposed.

There is also presented a vehicle wash facility equipped with an automated (“smart”) canopy system that is designed to automatically extend and retract canopy covers disposed over individual vehicle stalls in response to, e.g., inclement weather, high winds, earthquake, time of day, etc. The automated canopy system may include one or more sensing devices operable to monitor, for example, ambient temperature, wind speed, moisture, and/or barometric pressure, and output one or more electronic signals indicative of these monitored variables to an electronic controller. The electronic controller, in turn, processes and analyzes received sensor signals and, if the processed data is determined to meet at least one predetermined criteria, responsively outputs one or more command signals to a pneumatic, hydraulic, and/or electrical drive unit. The command signal(s) cause the drive unit to extend or retract the canopy cover, e.g., via folding, rolling, and or sliding the canopy cover on a subjacent canopy stand. The canopy system may optionally include a support stand constructed as a suspension framework composed of posts and/or rafters, one or more of which is fabricated with internal channels for housing electrical wiring (e.g., for speakers, lights, etc.) and/or fluid conduits (e.g., for vacuums, blowers, etc.). Another optional feature may include a photovoltaic panel that is mounted to the canopy support stand and operable to power the drive unit, electronic controller, and/or any attendant peripheral hardware.

Aspects of this disclosure are directed to a vacuum system for removing debris from a vehicle positioned at a vehicle stall of a vehicle wash facility. The vacuum system includes a vacuum hose that mounts proximate the vehicle stall, and has a snout that receives therethrough the debris. A central power unit is fluidly coupled to the vacuum hose, and selectively operable to generate a vacuum pressure sufficient to draw the debris into the vacuum hose snout. An exhaust heat recirculation system is fluidly connected to the central power unit, and operable to selectively evacuate and repurpose waste gases generated as a byproduct of operation of the central power unit.

Other aspects of this disclosure are directed to a method for assembling a vacuum system for removing debris from a vehicle positioned at a vehicle stall of a vehicle wash facility. The method may include, in any order and in any combination with any of the disclosed features and options: mounting a vacuum hose proximate the vehicle stall, the vacuum hose having a snout for receiving the debris; fluidly coupling the vacuum hose to a central power unit that generates a vacuum pressure sufficient to draw the debris into the vacuum hose through the snout; and, fluidly connecting an exhaust heat recirculation system to the central power unit, the exhaust heat recirculation system being operable to selectively evacuate and repurpose waste gases generated as a byproduct of operation of the central power unit.

Additional aspects of this disclosure are directed to self-service, hand-wash and automated vehicle wash facilities. For instance, a vehicle wash facility is presented that includes multiple vehicle stalls, each of which is designed to receive a vehicle. A respective vacuum hose is mounted proximate each one of the vehicle stalls for collecting debris from a vehicle. The vehicle wash facility is also equipped with a central power unit that is fluidly coupled to the vacuum hoses and operable to generate vacuum pressures sufficient to draw debris into each of the vacuum hoses. An exhaust heat recirculation system is fluidly connected to the central power unit, and operable to selectively evacuate and repurpose waste gases generated as a byproduct of operation of the central power unit.

Further aspects of this disclosure are directed to an exhaust heat recirculation system for a central vacuum system, which may be employed for vehicle and non-vehicle applications alike. The central vacuum system includes at least one vacuum hose, a motor-driven vacuum pump, and an inlet manifold fluidly coupling the vacuum pump to the vacuum hoses. The exhaust heat recirculation system includes a dryer unit with a dryer housing having an internal drying chamber. The dryer housing is fabricated with inlet and outlet ports for entering and exiting the drying chamber, and a dryer air intake port for fluidly connecting to the vacuum system. A fluid conduit fluidly couples the dryer air intake to a pump outlet of the motor-driven vacuum pump. An air filter is fluidly connected to the fluid conduit, located upstream from the dryer unit and downstream from the vacuum pump. The dryer unit is operable to selectively evacuate and repurpose exhaust gases generated via operation of the motor-driven vacuum pump. In an alternative application, the exhaust heat recirculation system includes a dryer unit with a dryer housing having an internal drying chamber. A heat exchanger operatively connects an exhaust outlet of the central power unit to the dryer unit to capture heat energy of the exhaust gas and use the captured heat energy to heat, or assist with heating, air used by the dryer unit.

For any of the disclosed systems, methods, and devices, the exhaust heat recirculation system may include a dryer unit that is fluidly connected to the central power unit to receive therefrom waste gases and utilize the received gases for a drying operation. As another option, the exhaust heat recirculation system may include an exhaust manifold that is fluidly connected to the central power unit to collect and vent waste gases from the central power unit. In yet another option, the exhaust heat recirculation system may include a filter that is fluidly connected to the central power unit to remove debris entrained in the waste gases. As an additional option, the exhaust heat recirculation system may include one or more electronically controlled fluid valves interposed between the central power unit, the dryer unit, the manifold, and/or the filter to regulate gas flow therebetween. The vacuum system may optionally include an electronic controller that is communicatively connected to and operable to govern operation of, among other things, the exhaust heat recirculation system, including the electronically controlled fluid valve(s).

For any of the disclosed systems, methods, and devices, the exhaust heat recirculation system may include an electric fan that is fluidly connected to the central power unit to create fluid flow sufficient to evacuate waste gases from the central power unit. As indicated above, the vehicle wash facility may optionally include multiple vehicle stalls with a respective vacuum hose mounted proximate each of the vehicle stalls. In this instance, the central power unit is fluidly coupled to the multiple vacuum hoses to generate vacuum pressures sufficient to draw debris into each vacuum hose. The byproduct waste gases may include ambient air that is heated, pressurized, and/or chemically-entrained through operation of the central power unit. As used herein, the term “vehicle” may include any relevant vehicle platform, such as passenger vehicles (internal combustion engine, hybrid electric, full electric, fuel cell, fuel cell hybrid, autonomous, etc.), commercial vehicles, industrial vehicles, tracked vehicles, off-road and all-terrain vehicles (ATV), recreational vehicles (RV), farm equipment, watercraft, aircraft, etc.

For any of the disclosed systems, methods, and devices, the exhaust heat recirculation system may include a dryer unit that fluidly connects to the central power unit to receive therefrom exhaust gases and utilize the received exhaust gases for carrying out a drying operation. The central power unit may include a motor-driven vacuum pump with a pump inlet upstream from the pump, and a pump outlet downstream from the pump. In this instance, the pump inlet fluidly connects to the vacuum hose, and the pump outlet fluidly connects to the dryer unit.

For any of the disclosed systems, methods, and devices, the dryer unit may include a dryer housing with an internal drying chamber, a conveyor system that extends through the drying chamber, and a dryer air intake fluidly connecting the dryer housing to the exhaust outlet of the vacuum pump. The conveyor system includes a driving spool spaced from a driven spool, both of which are packaged inside the dryer housing. An electric motor is drivingly connected to and selectively operable to rotate the driving spool. An open-mesh conveyor belt is drivingly mounted on the driving and driven spools. Rather than use a conveyor system, the dryer unit may employ a tumbling bin, a movable or stationary drying rack, or other suitable arrangement for a desired application. The dryer unit may include an array of air nozzles disposed inside the dryer housing and fluidly connected to the dryer air intake. The air nozzles dispense spaced discrete jets of exhaust gas into the drying chamber and across the conveyor belt.

The above summary is not intended to represent every embodiment or every aspect of the present disclosure. Rather, the foregoing summary merely provides an exemplification of some of the novel concepts and features set forth herein. The above features and advantages, and other features and advantages of this disclosure, will be readily apparent from the following detailed description of illustrated embodiments and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative vehicle wash facility equipped with a vacuum exhaust heat recirculation system and an automated canopy system in accordance with aspects of the present disclosure.

FIG. 2 is a perspective view illustration of a representative vehicle wash vacuum system with a continuous-belt conveyor dryer unit that repurposes exhaust gas from a motor-driven central vacuum pump in accordance with aspects of the present disclosure.

The present disclosure is amenable to various modifications and alternative forms, and some representative embodiments have been shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as defined by the appended claims.

### DETAILED DESCRIPTION

This disclosure is susceptible of embodiment in many different forms. Representative embodiments of the disclosure are shown in the drawings and will herein be described in detail with the understanding that these illustrated examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “comprising,” “having,” and the like, shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

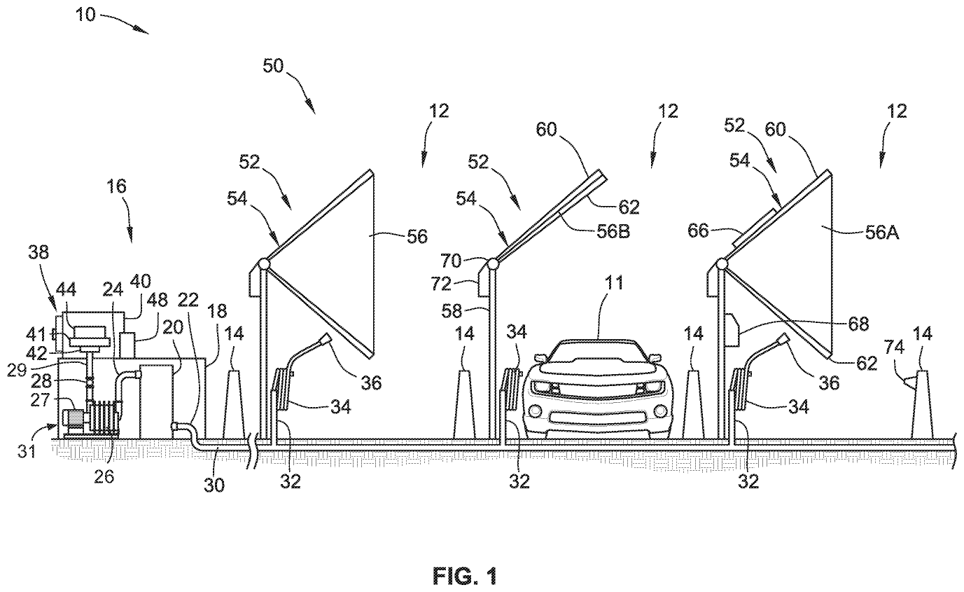

Referring now to the drawings, wherein like reference numbers refer to like features throughout the several views, there is shown in FIG. 1 a schematic illustration of a representative vehicle wash system, which is designated generally at 10 and portrayed herein for purposes of discussion as a coin-operated, self-service type car wash. The illustrated vehicle wash system 10—also referred to herein as “wash facility” or “car wash”—is merely an exemplary application with which novel aspects and features of this disclosure may be practiced. In the same vein, implementation of the present concepts into a car wash system for cleaning automobiles should also be appreciated as an exemplary application of the novel features disclosed herein. As such, it will be understood that aspects and features of the present disclosure may be applied to other types of vehicle wash systems, may be utilized for any logically relevant type of motorized vehicle, and may be incorporated into both vehicle and non-vehicle applications alike. Lastly, the drawings presented herein are not necessarily to scale and are provided purely for instructional purposes. Thus, the specific and relative dimensions shown in the drawings are not to be construed as limiting.

Vehicle wash system 10 of FIG. 1 is generally represented in the drawings by a series of neighboring vehicle stalls (or “car wash bays”) 12 that may be separated from one another by parking posts 14 or similarly suitable structure. Alternative architectures may replace each parking post 14 with sidewalls, a roof, and an optional entry/exit door (none of which are shown); alternatively, the posts 14 may be altogether eliminated. While not per se required, it may be desirable, e.g., for scalability, ease of manufacture, and speed of installment, that all of the vehicle stalls 12 be substantially identical at least in terms of wash-related equipment provided at each bay 12. In addition, the self-service car wash 10 is illustrated in FIG. 1 with only three car wash bays 12; nevertheless, it is envisioned that the vehicle wash facilities and systems of this disclosure may include any number of individual vehicle stalls, each of which may be similar to or distinct from one or more other vehicle stalls at the facility.

Only select components of the vehicle wash system 10 have been shown and will be described in additional detail herein; nevertheless, the system 10 may include numerous additional and alternative features, and other well-known peripheral components, for carrying out the methods and functions of this disclosure. By way of non-limiting example, the vehicle wash system 10 may furnish each vehicle stall 12 with equipment typical to a coin-operated, self-service car wash, including a pressurized water hose and associated spray wand (not shown) for pre-soaking a vehicle prior to cleaning, and for rinsing the vehicle after cleaning. In the same vein, a coin-receiving control box may be installed at each stall 12 to control timed delivery of pre-soak/rinse water, soap/soapy water, liquid wax, vacuum pressure, etc., as selected and paid for by the user. Alternatively, the vehicle wash system 10 may be embodied as an automated car wash, e.g., with a conveyorized tunnel wash, or as a hand-wash facility, e.g., with paid personnel that utilize the illustrated vehicle stalls 12 to complete one or more services as part of a car wash operation.

With continuing reference to FIG. 1, the vehicle wash system 10 is equipped with a “centralized” vacuum system, designated generally at 16, for removing debris from one or more vehicles 11 parked at the individual vehicle stalls 12 of the wash facility 10. Vacuum system 16 includes a main vacuum tank 18 housing a debris receptacle 20 that is interposed between tank inlet and outlet ducts 22 and 24, respectively. The inlet and outlet ducts 22 and 24 are connected, e.g., via strap clamps or other suitable attachment means, to the main vacuum tank 18 and to a vacuum pump 26. The vacuum pump 26 of FIG. 1 is driven by an electric or gas-powered motor 27. Vacuum pump 26 may take on any now known or hereinafter developed form, including as some non-limiting examples rotary vane pumps, diaphragm pumps, piston pumps, fan-type air pumps, reciprocating positive displacement pumps, rotary pumps, drag pumps, fluid entrainment pumps, turbine pumps, etc. A fluid check valve 28, which is shown coupled to an exhaust duct 29 fluidly downstream from receptacle 20 and pump 26, permits one-way flow of exhaust gases from the motor-driven vacuum pump 26. A vacuum relief valve (not shown) may also be coupled to the vacuum pump 26 in order to limit the amount of debris pulled by the vacuum pump 26 by allowing a metered amount of air into the system 16 whenever a set point of the relief valve is exceeded while preventing the system 16 from shutting down.

A series of vacuum feeders 32 are fluidly connected to the vacuum inlet duct 22 via inlet manifold 30. Coupler ends of the vacuum feeders 32, which may be normally sealed by a spring-loaded gasket cover (not shown), each connect in an air-tight manner to a tubular vacuum hose 34. Each hose 34 has a distal opening or “snout” 36 through which debris is received via the hose 34. The vacuum pump 26 and associated motor 27—representative herein of and collectively referred to interchangeably as a “central power unit” 31—is fluidly coupled to the assorted vacuum hoses 34, e.g., via the inlet duct 22, inlet manifold 30, and vacuum feeders 32. Pump 26 is powered to generate a vacuum pressure that is sufficient to create an airflow, via suction, where debris becomes entrained in the airflow and is drawn into the snouts 36 of the various hoses 34, through the inlet manifold 30 and inlet duct 22, and into the receptacle 20. Once inside the receptacle 20, a separator (not shown) cases the debris to separate from the air and remain inside the receptacle 20; the air continues to flow through the receptacle 20 and exit through the outlet 24, e.g., at ambient temperature. The air enters the vacuum pump 26 where, inside the pump 26, the air flow past the motor cools the motor, and causes the air to become heated air. The temperature of the heated air, once exhausted from the vacuum pump 26, is greater than the ambient temperature (e.g., exceeding 40° C. or 104° F.). In one non-limiting example, the exhaust temperature of the exhausted air is between 40° C. (104° F.) and 100° C. (212° F.). The heated air is exhausted from the vacuum pump 26, as exhaust air, through the exhaust outlet duct 29. While illustrated in FIG. 1 as a central vacuum system with a single vacuum pump 26, it is envisioned that the vacuum system 16 take on other vacuum system architectures with any number of vacuum pumps (e.g., individual vacuums located at the individual stalls 12).

Operation of a conventional car wash facility oftentimes requires large amounts of electricity to drive the many individual washing, drying and vacuuming units, and results in the release of voluminous amounts of heated exhaust gases from the vacuuming and drying systems. Vacuum system 16 is stock equipped or retrofit to include a vacuum exhaust heat recirculation system 38 to help minimize power consumption at the car wash facility 10 (e.g., by reducing or eliminating the need to power a separate heating device to operate a dryer unit), and to help reduce the overall volume of heated exhaust gases released into the atmosphere (e.g., by reducing or eliminating the need to generate hot air (e.g., at about 120° C. or higher) dedicated to operating the dryer unit). In addition to reducing startup and overhead costs, while helping to minimize the wash facility's carbon footprint, disclosed exhaust recirculation techniques also help to improve system operating efficiency by providing a faster, more economical way to collect, dry, and disseminate tunnel cloths, towels, brushes, etc.

The vacuum exhaust heat recirculation system 38 is fluidly connected to the central power unit, i.e., one or more motor-driven vacuum pump 26, and operable to selectively evacuate and repurpose heated air (e.g., waste gases) or capture and repurpose only the waste heat of the exhaust gases generated as a byproduct of operation of the central power unit 31. Heated waste gases of the vacuum system 16 may include ambient air that is heated, pressurized, and/or chemically-entrained through operation of the central power unit 31. In accord with the illustrated architecture, the exhaust heat recirculation system 38 is furnished with a dryer unit 40 that is fluidly connected to the central power unit 31, e.g., via the outlet duct 24 and fluid check valve 28. Dryer unit 40 receives waste gases from the central power unit 31 and utilizes the received waste gases for a drying operation, for example, to dry towels, sponges, employee uniforms, mitter cloth strips, drying material, vehicles, etc. The drying material is absorbent material that is used to engage an exterior of a vehicle to remove water accumulated thereon. Further, the drying material (not shown) may be disposed on a rotatable drying wheel (not shown), where the drying material may engage an exterior of the vehicle to remove water accumulated thereon, as the drying material absorbs the water, that can be used with the drying unit 40. The conventional equivalent drying wheel and drying material are disclosed in U.S. Pat. No. 9,328,959, entitled “Vehicle Wash Drying System,” issued on May 3, 2016, and U.S. Publication No. U.S. 2016/0238316, entitled “Vehicle Wash Drying System,” filed Apr. 25, 2016, which are hereby incorporated for all purposes.

The dryer unit 40 may be one or more vents or nozzles that serve as blowers to selectively or continuously operate to blow heated air onto the drying material to assist with evaporation of the water that has been absorbed by the drying material. Alternatively, the vents or nozzles may selectively or continuously operate to blow heated air onto the exterior of the vehicle to cause evaporation of the water accumulated thereon. The dryer unit 40 may be disposed in a location of the vehicle wash facility that is spaced from the location of the vacuum pump 26, motor 27, via ducting 29 and the like. This spacing provides a drying process with reduced noise, since the blower motors that are typically present within the vehicle wash facility to blow air onto the vehicles would be located remote from the drying area of the vehicle wash facility. An example of a conventional equivalent nozzle is disclosed in U.S. Pat. No. 8,505,213, entitled “Extendable Nozzle for a Vehicle Drying Apparatus,” issued on Aug. 13, 2013.

Optional and alternative system configurations may utilize the repurposed waste gases for other processes, such as drying washed vehicles, heating water, heating air for an HVAC system, generating electricity, providing pressurized air for operating pneumatically driven tools and devices, etc. In accord with the illustrated example, the dryer unit 40 of FIG. 1 is a front-load, tumble-style dryer that salvages heat and air generated through operation of the central power unit 31, rather than drawing in and heating ambient air that is passed through an internal tumbler.

To control the intake, collection, and distribution of exhaust gases received from the vacuum pump 26, the exhaust heat recirculation system 38 employs an exhaust manifold assembly 41 that is fluidly connected to the central power unit 31 and designed to govern the accumulation and dispensation of waste gases vented therefrom. For instance, the exhaust manifold assembly 41 may be configured as an exhaust manifold for collecting and aggregating gases expelled from multiple motor-driven vacuum pumps 26. Conversely, the exhaust manifold assembly 41 may be configured as an intake manifold for segregating and distributing collected gases to multiple dryer units 40 and/or other system devices designed to exploit the exhaust gases.

Other optional equipment may include a filter 42 that is fluidly connected to the central power unit 31, e.g., upstream from the manifold assembly 41 and downstream from the pump 26. Alternative architectures may place the filter 42 upstream from the central power unit 31, e.g., to protect the pump 26 from cavitation or clogging. The filter 42 may be in the nature of a coarse, fine, or HEPA filter that removes solid particulates, such as dirt, dust, pollen, mold, and/or bacteria from the exhaust gases. It is further envisioned that the filter 42 contain an absorbent or catalyst to remove odors and entrained pollutants. Exhaust heat recirculation system 38 may also include one or more electronically controlled fluid valves 44 that control gas flow between any combination of components of the system 38. To create fluid flow sufficient to evacuate waste gases from the main vacuum tank 18 to the dryer unit 40, an optional electric fan 46 may be disposed inside or may be operatively connected to the tank 18 and/or the dryer unit(s) 40 and electronically controlled to create additional air flow. An electronic controller 48 is connected—wired or wirelessly—to any one or more or all of the electronic devices of the exhaust heat recirculation system 38 and operable to cooperatively govern operation of these devices. As indicated above, the system 16 may be adapted to capture and repurpose heat generated by the central power unit 31 for use in a heat exchanger, electric motor generator, water heater, and other suitably relevant implementations.

Continuing with the discussion of the vehicle wash system 10 of FIG. 1, an automated or “smart” canopy system 50 is provided for selectively covering and uncovering vehicles 11 that are parked in or otherwise located at the individual vehicle stalls 12. It should be noted that use of the terms “cover” and “uncovering” (including permutations thereof) to describe the canopy structures of this disclosure do not explicitly require the canopy structure completely conceal or completely expose a vehicle, respectively. By way of example, and not limitation, a canopy unit 52 can be said to “cover” a vehicle 11 when the canopy cover 56 provides shade for some or all of the vehicle 11. In the same vein, the canopy unit 52 can be said to “uncover” a vehicle 11 when the canopy cover 56 exposes most or all of the vehicle 11 to sun rays, rain, etc.

In accord with the representative architecture illustrated in the drawings, the canopy system 50 includes a sequence of canopy units 52, each of which is generally composed of a canopy support stand 54 that mounts proximate a vehicle stall 12, and a canopy cover 56 that is attached to the canopy support stand 54. Although shown with three substantially identical canopy units 52, it is envisioned that the automated canopy system 50 may include any number of individual canopy units 52, each of which may be similar to or distinct from one or more other canopy units 52 at the car wash facility 10. As a further option, two or more of the vehicle stalls 12 may share a single canopy unit 52 that is deployable to cover single or multiple stalls 12 at a given time. For ease of manufacture, installation, and operation, some or all of the structural characteristics of the disclosed canopy units 52 may be substantially identical; thus, for purposes of brevity, the structural features of all three illustrated canopy units 52 may be described by way of reference to the rightmost unit 52 presented in FIG. 1.

Canopy support stand 54 is illustrated in FIG. 1 as a freestanding, rigid fixture that provides subjacent, operative support for a corresponding canopy cover 56. As shown, the support stand 54 can be fabricated as a suspension-type framework composed of a stanchion post 58 that is interconnected with a pair of rafters 60 and 62. These rafters 60, 62 are cantilevered at proximate ends thereof to the stanchion post 58 to cooperatively suspend the canopy cover 56 over the vehicle 11. It is within the scope of this disclosure for a canopy unit 52 to employ more than one canopy cover 56 as well as a canopy stand 54 with any number of posts and rafters. In this regard, the canopy stand 54 may take on other canopy configurations, including umbrella, open-wall, closed-wall, arched, tent arrangements, and the like. As another option, the post 58 and/or one or more of the rafters 60, 62 may be tubular structures with an internal channel or a series of interconnected internal channels that house therein a conduit 64, which may be in the nature of an electrical wire or wiring harness (e.g., to power a speaker or intercom component) and/or a fluid hose or fluid-tight channel (e.g., one of the vacuum feeders 32 for the vacuum system 16).

Other optional hardware may include a photovoltaic panel 66 (more commonly known as a “solar cell”) that may be mounted to the canopy unit 52, e.g., to the upper most end of the stanchion post 58 or onto one of the rafters 60, 62. This photovoltaic panel 66 includes solar cells that capture solar energy—radiant light and heat from the sun—and convert that energy into an electric current, e.g., to power any of the electronic devices illustrated in FIG. 1. Mounted to the canopy unit 52 of FIG. 1 is an optional user input device 68, such as a human machine interface (HMI) or other suitable electronic interface, that is operable to receive inputs from users, and transmit electronic signals indicative thereof to the electronic controller 48 or other electronic control unit (ECU), logic circuit, or central computing device.

With continuing reference to the representative architecture of FIG. 1, the canopy cover 56 is movably mounted onto the canopy stand 54 to transition back-and-forth between a deployed position (designated as 56A in FIG. 1) and a stowed position (designated as 56B). When in the deployed position, the canopy cover 56 may block direct sunlight from contacting some or all of the vehicle 11. Conversely, when moved to the stowed position, the canopy cover 56 allows direct sunlight to contact some or all of the vehicle 11. In the illustrated example, proximal ends of the rafters 60, 62 are pivotably mounted onto the canopy support stand 54, e.g., via a rotary joint 70, in a fan-like configuration that allows the canopy cover 56 to fold and, when desired, unfold. For at least some applications, it is desirable that the deployment and storage of the canopy covers 56 be fully automated; however, it is within the scope of this disclosure for the canopy unit 52 to be manually and electronically operated by a user. In addition, the canopy unit 52 may take on any suitable configuration, including roll-up type assemblies, sliding screen assemblies, Roman shade configurations, accordion arrangements, collapsible umbrella, etc.

An electronically controlled drive unit 72 may be operatively connected to the canopy unit 52 to selectively shift the canopy cover 56 between the deployed and stowed positions. Electronic controller 48 of FIG. 1 is connected—wired or wirelessly—to the various canopy units 52 to regulate operation of the drive unit 72 and thereby control the selective deployment and storage of the canopy cover 56. The drive unit 72 may be mounted on the stanchion post 58 or one of the rafters 60, 62, or may be mounted adjacent the support stand 54 or in a centralized location (e.g., as a central drive unit). Drive unit 72 may take on any available apparatus that is suitable for enabling movement of the canopy cover 56, including one or more electronically controlled actuators, such as hydraulic actuators, pneumatic actuators, smart-material driven actuators, and/or electric actuators. Optionally or alternatively, the drive unit 72 may generally consist of a two-way electric stepper motor or other bidirectional electric motor configuration, and a mechanical transmission that operatively couples the electric motor to the canopy cover 56. The mechanical transmission may provide speed and/or torque amplification, and may convert rotational power generated by the motor into linear or rotational forces to move the canopy cover 56. As some non-limiting examples, the mechanical transmission may comprise a gear train system, a chain drive system, and/or a belt drive system.

One or more sensing devices 74 may be dispersed throughout the car wash facility 10, and operable to monitor a selected set of variables that generally or directly relate to operation of the vehicle wash facility 10. For instance, the sensing device(s) 74 may monitor ambient temperature, wind speed, moisture, ambient light, ultraviolet light, and/or barometric pressure, and output one or more electronic sensor signals indicative thereof to the electronic controller 48. Additionally, the controller 48 may communicate, e.g., via a wired or wireless network, with one or more remote computing devices, sensors, etc., to track other variables that may relate to operation of the vehicle wash facility 10. The electronic controller 48, in turn, may be programmed to store, filter, process, fuse, and/or analyze the electronic sensor signal(s) received from these various sources of data to determine whether or not a monitored variable meets a corresponding predetermined criterion. For instance, a sensing device 74 may monitor sunlight to determine whether it is nighttime or daytime and/or measure the ultraviolet (UV) index to determine, in real-time, the strength of UV radiation. As another option, the electronic controller 48 may communicate with a local weather reporting agency to determine whether or not inclement weather is expected. As yet a further option, the controller 48 may maintain an internal clock to determine if a current time is within a designated time window (e.g., the normal hours of operation of the vehicle wash facility 10). In response to a determination that any one of the monitored variables meets at least one predetermined criteria, the controller 48 transmits an electronic command signal to the drive unit 72 to transition the canopy cover 56 from the deployed position to the stowed position or from the stowed position to the deployed position.

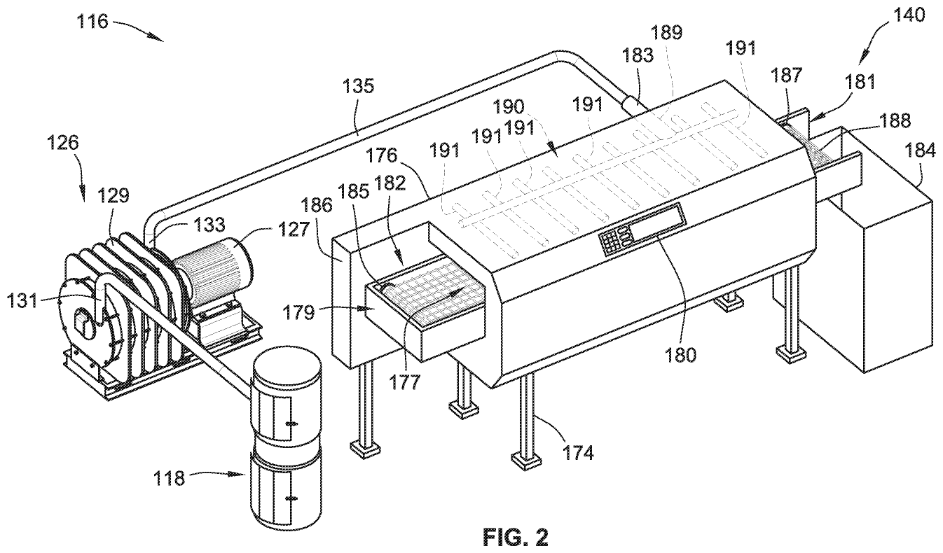

Turning next to FIG. 2, wherein similar reference numbers are used to refer to similar features from FIG. 1, there is shown a central vacuum system, designated generally at 116, with a motor-driven, centrifugal-fan type vacuum pump 126 that feeds exhaust gas to a continuous-belt, conveyor-type dryer unit 140 that repurposes vacuum pump exhaust gas for completing a drying operation. While differing in appearance, it is envisioned that any of the features, options and alternatives disclosed above with reference to the system architecture of FIG. 1 can be incorporated, singly or in any combination, into the system architecture of FIG. 2, and vice versa. Similar to the vacuum pump 26 of FIG. 1, for example, vacuum pump 126 of FIG. 2 is electrically powered to generate a sufficiently high vacuum pressure to draw debris through a series of interconnected vacuum hoses and into a central debris receptacle stowed inside a main vacuum tank 118. Vacuum pump 126 includes a 50 hp multiphase electric motor 127 that drives a vane-cooled air turbine 129 with a 25-inch impeller that moves enough fluid volume to simultaneously operate up to 20 individual hoses across a 200-foot pipe run. A pump inlet (or “intake”) 131, which is upstream from the air turbine 129, fluidly connects the vacuum pump 126 to the vacuum hoses via the vacuum tank 118. In this regard, a pump outlet (or “exhaust”) 133, which is downstream from the air turbine 129, fluidly connects the vacuum pump 126 to an air intake 183 of the dryer unit 140 via tubing, elbows, wet-flow couplings or any other suitable fluid conduit (collectively designated 135).

With continuing reference to FIG. 2, the dryer unit 140 is a free-standing construction with a multi-legged pedestal arrangement 174 providing subjacent support for a thermally insulated dryer housing 176. Dryer housing 176 has an elongated geometry with a generally rectangular longitudinal cross-section and a polygonal transverse cross-section. Opposing open ends of the dryer housing 176 are provided with input and output bays 179 and 181, respectively, through which objects being dried enter and exit an internal drying chamber 177. An optional graphical human machine interface (HMI) 180 with an electronic display screen and button pad may be provided to allow users to enter inputs that control various operating parameters of the dryer unit 140, such as temperature, speed, time, etc. Alternative embodiments, such as countertop and cantilevered configurations, may eliminate the pedestal arrangement 174 from the dryer unit 140. It should also be recognized that the shape and size of the dryer unit 140 may be modified for ease of scalability and to comply with footprint restrictions. Further options may include doors or sliding panels (not shown) mounted to selectively cover and uncover the open ends of the dryer housing 176.

A conveyor system 182 extends from the input bay 179, through the drying chamber 177, and across the output bay 181 to deposit dried objects in a bin 184 at the distal end of the dryer unit 140. This conveyor system 182 is equipped with a driving spool 185 that is mounted within the input bay 179 at the proximal end of the housing 176, a driven spool 187 that is mounted within the output bay 181 at the distal end of the housing 176, and a sequence of equidistantly spaced support rollers (not shown) rotatably mounted within the drying chamber 177 between the driving and driven spools 185, 187. An electric motor 186 is mechanically coupled to and selectively operable to drive the driving spool 185 to thereby effectuate operation of the conveyor system 182. Mounted on the driving and driven spools 185, 187 is a metallic, open-mesh conveyor belt 188 that extends continuously from the input bay 179, through the drying chamber 177, to the output bay 181, and back the input bay 179. It should be appreciated that conveyor belt 188 may take on other conventional continuous belt configurations, including non-mesh and non-metallic permutations thereof, and may be movably mounted for movement right-to-left and/or left-to-right, e.g., for reversible implementations.

During operation of the central vacuum system 116 of FIG. 2, exhaust gases from the vacuum pump 126 are expelled from the pump outlet 133, moved through the fluid conduit 135, and into the dryer unit 140 through dryer air intake 183. Received exhaust gases transfer from the air intake 183, through an air plenum 189, and into an air rail system, which is shown hidden at 190 in FIG. 2. The representative air rail system 190 is equipped with a distributed array of air nozzles, namely seven (7) rows of plain-orifice spray nozzle branches 191 that are interconnected with a main air rail 193. These mutually parallel spray nozzle branches 191 are mounted inside the drying chamber 177, spaced longitudinally along the length of the dryer housing 176. A series of air nozzles projects from an underside of each nozzle branch 191 to dispense spaced discrete jets of the exhaust gas into the drying chamber 177 and across the conveyor belt 188. It may be desirable for each of the nozzles to have an air-blade like rectangular cross-section, while the main air rail 193 is provided with baffles to equalize the pressure across the entire width of the nozzles.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and obvious variations apparent from the foregoing descriptions are within the scope of the disclosure as defined by the appended claims. Moreover, the present concepts expressly include any and all combinations and subcombinations of the preceding elements and features.

What is claimed:

1. A central vacuum system comprising:
a vacuum hose having a snout configured to receive therethrough air and debris;
a central power unit fluidly coupled to the vacuum hose and configured to generate a vacuum pressure sufficient to continuously draw the air, at an ambient temperature, and debris from the vacuum hose to flow through the central power unit, such that the flow of the air through the central power unit cools the central power unit and causes the temperature of the air to increase from the ambient temperature to an exhaust temperature,
wherein the central power unit is configured to continuously exhaust the air, at the exhaust temperature; and
an exhaust heat recirculation system configured to be operatively connected to the central power unit and operable to selectively capture heat from the exhaust air, at the exhaust temperature, and repurpose the captured heat generated via operation of the central power unit.

2. The central vacuum system of claim 1, wherein the exhaust heat recirculation system includes a dryer unit configured to be operatively connected to the central power unit and configured to receive therefrom heat captured from the exhaust air and utilize the received heat for a drying operation.

3. The central vacuum system of claim 2, wherein the central power unit includes a vacuum pump, a pump inlet upstream from the vacuum pump, and a pump outlet downstream from the vacuum pump, the pump inlet configured to be fluidly connected to the vacuum hose, and the pump outlet configured to be fluidly connected to the dryer unit.

4. The central vacuum system of claim 2, wherein the dryer unit includes a dryer housing defining therein a drying chamber, a conveyor system extending through the drying chamber, and a dryer air intake configured to fluidly connect the dryer housing to the pump outlet.

5. The central vacuum system of claim 2, wherein the exhaust air recirculation system includes at least one air nozzle configured to selectively dispense a stream of heated air to perform the drying operation.

6. The central vacuum system of claim 4, wherein the conveyor system includes a driving spool spaced from a driven spool within the dryer housing, a motor selectively operable to drive the driving spool, and an open-mesh conveyor belt drivingly mounted on the driving and driven spools.

7. The central vacuum system of claim 5, wherein the dryer unit further includes at least one air nozzle disposed inside the dryer housing and configured to be fluidly connected to the dryer air intake, the array of air nozzles being configured to dispense spaced discrete jets of the exhaust gases into the drying chamber and across the conveyor belt.

8. The central vacuum system of claim 2, wherein the exhaust heat recirculation system further includes a first electronically controlled fluid valve configured to be interposed between the central power unit and the dryer unit and configured to control gas flow therebetween.

9. The central vacuum system of claim 1, wherein the vacuum hose includes a plurality of vacuum hoses each configured to mount proximate a respective one of a plurality of vehicle stalls of a vehicle wash facility, the vacuum system further comprising an inlet manifold configured to fluidly connect the plurality of vacuum hoses to the central power unit.

10. The central vacuum system of claim 9, wherein the exhaust heat recirculation system further includes a second electronically controlled fluid valve interposed between the central power unit and the filter and configured to control gas flow therebetween.

11. The central vacuum system of claim 1, wherein the exhaust heat recirculation system further includes a filter fluidly connected to the central power unit and configured to remove debris entrained in the exhaust gases.

12. The central vacuum system of claim 1, further comprising an electronic controller communicatively connected to and operable to govern operation of the exhaust heat recirculation system.

13. The central vacuum system of claim 1, further comprising a fan configured to be operatively connected to the central power unit and configured to create fluid flow sufficient to evacuate the exhaust gases from the central power unit.

14. The central vacuum system of claim 1, wherein the vacuum system is part of a vehicle wash facility, the vehicle wash facility including a plurality of vehicle stalls, wherein the vacuum hose includes a plurality of vacuum hoses each configured to mount proximate a respective one of the vehicle stalls, and wherein the central power unit is fluidly coupled to the plurality of vacuum hoses and configured to generate a vacuum pressure sufficient to draw air and debris into each of the vacuum hoses.

15. An exhaust heat recirculation system for a central vacuum system, the central vacuum system including at least one vacuum hose and a vacuum pump fluidly coupled to the at least one vacuum hose, the exhaust heat recirculation system comprising:
a dryer unit with a dryer housing defining therein a drying chamber, and a dryer air intake operatively connected to the dryer housing; and
a fluid conduit configured to operatively couple the dryer air intake to a pump outlet of the motor-driven vacuum pump,
wherein the fluid conduit is operable to selectively capture heat from heated air exhausted from the vacuum pump, and
wherein the dryer unit is operable to selectively repurpose the captured heat from the fluid conduit generated via operation of the motor-driven vacuum pump.

16. A method of assembling a central vacuum system, the method comprising:
providing a vacuum hose having a snout configured to receive therethrough air and debris;
operatively coupling the vacuum hose to a central power unit configured to generate a vacuum pressure sufficient to draw the air and debris through the vacuum hose and exhaust the air; and
operatively connecting an exhaust heat recirculation system to the central power unit, the exhaust heat recirculation system being operable to selectively capture heat from the exhaust air and repurpose the captured heat generated via operation of the central power unit.

17. The method of claim 16, wherein the exhaust heat recirculation system includes a dryer unit operatively connected to the central power unit and configured to receive therefrom heat captured from the exhaust air and utilize the received heat for a drying operation.

18. The method of claim 17, wherein the central power unit includes a motor-driven vacuum pump, a pump inlet upstream from the vacuum pump, and a pump outlet downstream from the vacuum pump, and wherein the fluidly coupling includes connecting the pump inlet to the vacuum hose, and the fluidly connecting including includes connecting the pump outlet to the dryer unit.

19. The method of claim 18, wherein the dryer unit includes a dryer housing defining therein a drying chamber, a conveyor system extending through the drying chamber, and a dryer air intake fluidly connecting the dryer housing to the pump outlet.

20. The method of claim 19, wherein the conveyor system includes a driving spool spaced from a driven spool within the dryer housing, an electric motor selectively operable to drive the driving spool, and an open-mesh conveyor belt drivingly mounted on the driving and driven spools.
